(19) United States
(12) Patent Application Publication
(10) Pub. No.: US 2022/0264111 A1
(43) Pub. Date: Aug. 18, 2022

(54) VIDEO CODING EFFICIENCY IMPROVEMENT USING DYNAMIC FRAME BOOST SCALING

(71) Applicant: Meta Platforms, Inc., Menlo Park, CA (US)

(72) Inventors: Gaurang Chaudhari, San Jose, CA (US); Igor Koba, Santa Clara, CA (US); Harikrishna Madadi Reddy, San Jose, CA (US)

(21) Appl. No.: 17/569,414

(22) Filed: Jan. 5, 2022

Related U.S. Application Data
(60) Provisional application No. 63/149,245, filed on Feb. 13, 2021.

(51) Int. Cl. H04N 19/149; H04N 19/105; H04N 19/30; H04N 19/159; H04N 19/172

(52) U.S. Cl. CPC H04N 19/149; H04N 19/105; H04N 19/172; H04N 19/159; H04N 19/30

(57) ABSTRACT

A video to be encoded using a codec is received. A first-pass analysis of the frames of the video is performed, including by collecting first-pass statistics data for each of the frames of the video. A specific frame of the video is selected for boosting an encoding rate of the specific frame. At least a portion of the first-pass statistics data is provided to a model to determine a boost factor for the specific frame. The encoding rate for the specific frame is determined using the boost factor.

### CROSS REFERENCE TO OTHER APPLICATIONS

This application claims priority to U.S. Provisional Patent Application No. 63/149,245 entitled VIDEO CODING EFFICIENCY IMPROVEMENT USING DYNAMIC FRAME BOOST SCALING filed Feb. 13, 2021 which is incorporated herein by reference for all purposes.

### BACKGROUND

A video coding format is a content representation format for storage or transmission of digital video content (such as in a data file or bitstream). It typically uses a standardized video compression algorithm. Examples of video coding formats include H.262 (MPEG-2 Part 2), MPEG-4 Part 2, H.264 (MPEG-4 Part 10), HEVC (H.265), Theora, RealVideo RV40, VP9, and AV1. A video codec is a device or software that provides encoding and decoding for digital video. Most codecs are typically implementations of video coding formats.

Recently, there has been an explosive growth of video usage on the Internet. Some websites (e.g., social media websites or video sharing websites) may have billions of users and each user may upload or download one or more videos each day. When a user uploads a video from a user device onto a website, the website may store the video in one or more different video coding formats, each being compatible with or more efficient for a certain set of applications, hardware, or platforms. Therefore, higher video compression rates are desirable. For example, VP9 offers up to 50% more compression compared to its predecessor. However, with higher compression rates come higher computational complexity; therefore, improved hardware architecture and techniques in video coding would be desirable.

### BRIEF DESCRIPTION OF THE DRAWINGS

Various embodiments of the disclosure are disclosed in the following detailed description and the accompanying drawings.

FIG. 1 illustrates a block diagram of an embodiment of a video encoder 100.

FIG. 2 illustrates an exemplary block diagram of RDO module 130.

FIG. 3 illustrates a process 300 for a second main encoding pass in libvpx.

FIG. 4 illustrates an exemplary process 400 for determining the keyframe group.

FIG. 5 illustrates an exemplary process 500 for determining the golden frame (gf) group.

FIG. 6 illustrates an exemplary process 600 for determining the quantization parameter (QP).

### DETAILED DESCRIPTION

The disclosure can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the disclosure may take, may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the disclosure is provided below along with accompanying figures that illustrate the principles of the disclosure. The disclosure is described in connection with such embodiments, but the disclosure is not limited to any embodiment. The scope of the disclosure is limited only by the claims and the disclosure encompasses numerous alternatives, modifications and equivalents. Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

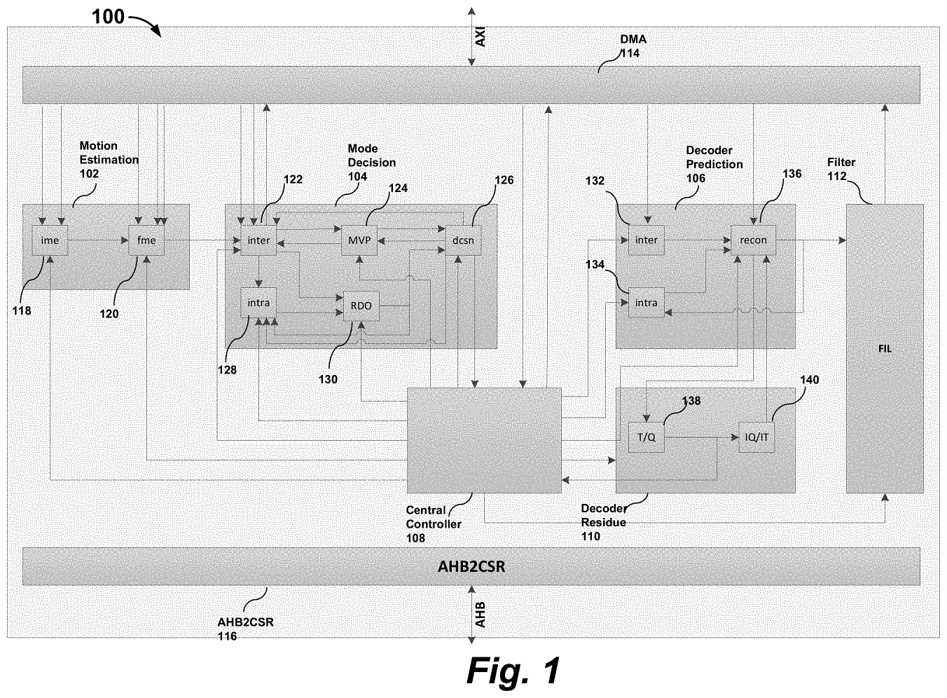

FIG. 1 illustrates a block diagram of an embodiment of a video encoder 100. For example, video encoder 100 supports the video coding format VP9. However, video encoder 100 may also support other video coding formats as well, such as H.262 (MPEG-2 Part 2), MPEG-4 Part 2 H.264 (MPEG-4 Part 10), HEVC (H.265), Theora and Real Video RV40.

Video encoder 100 includes many modules. Some of the main modules of video encoder 100 are shown in FIG. 1. As shown in FIG. 1, video encoder 100 includes a direct memory access (DMA) controller 114 for transferring video data. Video encoder 100 also includes an AMBA (Advanced Microcontroller Bus Architecture) to CSR (control and status register) module 116. Other main modules include a motion estimation module 102, a mode decision module 104, a decoder prediction module 106, a central controller 108, a decoder residue module 110, and a filter 112.

Video encoder 100 includes a central controller module 108 that controls the different modules of video encoder 100, including motion estimation module 102, mode decision module 104, decoder prediction module 106, decoder residue module 110, filter 112, and DMA controller 114.

Video encoder 100 includes a motion estimation module 102. Motion estimation module 102 includes an integer motion estimation (IME) module 118 and a fractional motion estimation (FME) module 120. Motion estimation module 102 determines motion vectors that describe the transformation from one image to another, for example, from one frame to an adjacent frame. A motion vector is a two-dimensional vector used for inter-frame prediction; it refers the current frame to the reference frame, and its coordinate values provide the coordinate offsets from a location in the current frame to a location in the reference frame. Motion estimation module 102 estimates the best motion vector, which may be used for inter prediction in mode decision module 104. An inter coded frame is divided into blocks, e.g., prediction units or partitions within a macroblock. Instead of directly encoding the raw pixel values for each block, the encoder will try to find a block similar to the one it is encoding on a previously encoded frame, referred to as a reference frame. This process is done by a block matching algorithm. If the encoder succeeds on its search, the block could be encoded by a vector, known as a motion vector, which points to the position of the matching block at the reference frame. The process of motion vector determination is called motion estimation.

Video encoder 100 includes a mode decision module 104. The main components of mode decision module 104 include an inter prediction module 122, an intra prediction module 128, a motion vector prediction module 124, a rate-distortion optimization (RDO) module 130, and a decision module 126. Mode decision module 104 detects one prediction mode among a number of candidate inter prediction modes and intra prediction modes that gives the best results for encoding a block of video.

Intra prediction is the process of deriving the prediction value for the current sample using previously decoded sample values in the same decoded frame. Intra prediction exploits spatial redundancy, i.e., correlation among pixels within one frame, by calculating prediction values through extrapolation from already coded pixels for effective delta coding. Inter prediction is the process of deriving the prediction value for the current frame using previously encoded reference frames. Inter prediction exploits temporal redundancy.

Rate-distortion optimization (RDO) is the optimization of the amount of distortion (loss of video quality) against the amount of data required to encode the video, i.e., the rate. RDO module 130 provides a video quality metric that measures both the deviation from the source material and the bit cost for each possible decision outcome. Both inter prediction and intra prediction have different candidate prediction modes, and inter prediction and intra prediction that are performed under different prediction modes may result in final pixels requiring different rates and having different amounts of distortion and other costs.

For example, different prediction modes may use different block sizes for prediction. In some parts of the image there may be a large region that can all be predicted at the same time (e.g., a still background image), while in other parts there may be some fine details that are changing (e.g., in a talking head) and a smaller block size would be appropriate. Therefore, some video coding formats provide the ability to vary the block size to handle a range of prediction sizes. The decoder decodes each image in units of superblocks (e.g., 128×128 or 64×64 pixel superblocks). Each superblock has a partition that specifies how it is to be encoded. Superblocks may be divided into smaller blocks according to different partitioning patterns. This allows superblocks to be divided into partitions as small as 4×4 pixels.

Besides using different block sizes for prediction, different prediction modes may use different settings in inter prediction and intra prediction. For example, there are different inter prediction modes corresponding to using different reference frames, which have different motion vectors. For intra prediction, the intra prediction modes depend on the neighboring pixels, and in VP9, the modes include DC, Vertical, Horizontal, TM (True Motion), Horizontal Up, Left Diagonal, Vertical Right, Vertical Left, Right Diagonal, and Horizontal Down.

RDO module 130 receives the output of inter prediction module 122 corresponding to each of the inter prediction modes and determines their corresponding amounts of distortion and rates, which are sent to decision module 126. Similarly, RDO module 130 receives the output of intra prediction module 128 corresponding to each of the intra prediction modes and determines their corresponding amounts of distortion and rates, which are also sent to decision module 126.

In some embodiments, for each prediction mode, inter prediction module 122 or intra prediction module 128 predicts the pixels, and the residual data (i.e., the differences between the original pixels and the predicted pixels) may be sent to RDO module 130, such that RDO module 130 may determine the corresponding amount of distortion and rate. For example, RDO module 130 may estimate the amounts of distortion and rates corresponding to each prediction mode by estimating the final results after additional processing steps (e.g., applying transforms and quantization) are performed on the outputs of inter prediction module 122 and intra prediction module 128.

Decision module 126 evaluates the cost corresponding to each inter prediction mode and intra prediction mode. The cost is based at least in part on the amount of distortion and the rate associated with the particular prediction mode. In some embodiments, the cost (also referred to as rate distortion cost, or RD Cost) may be a linear combination of the amount of distortion and the rate associated with the particular prediction mode; for example, RD Cost=distortion+λ*rate, where λ is a Lagrangian multiplier. The rate includes different components, including the coefficient rate, mode rate, partition rate, and token cost/probability. Other additional costs may include the cost of sending a motion vector in the bit stream. Decision module 126 selects the best inter prediction mode that has the lowest overall cost among all the inter prediction modes. In addition, decision module 126 selects the best intra prediction mode that has the lowest overall cost among all the intra prediction modes. Decision module 126 then selects the best prediction mode (intra or inter) that has the lowest overall cost among all the prediction modes. The selected prediction mode is the best mode detected by mode decision module 104.

After the best prediction mode is selected by mode decision module 104, the selected best prediction mode is sent to central controller 108. Central controller 108 controls decoder prediction module 106, decoder residue module 110, and filter 112 to perform a number of steps using the mode selected by mode decision module 104. This generates the inputs to an entropy coder that generates the final bitstream. Decoder prediction module 106 includes an inter prediction module 132, an intra prediction module 134, and a reconstruction module 136. If the selected mode is an inter prediction mode, then the inter prediction module 132 is used to do the inter prediction, whereas if the selected mode is an intra prediction mode, then the intra prediction module 134 is used to do the intra prediction. Decoder residue module 110 includes a transform and quantization module (T/Q) 138 and an inverse quantization and inverse transform module (IQ/IT) 140.

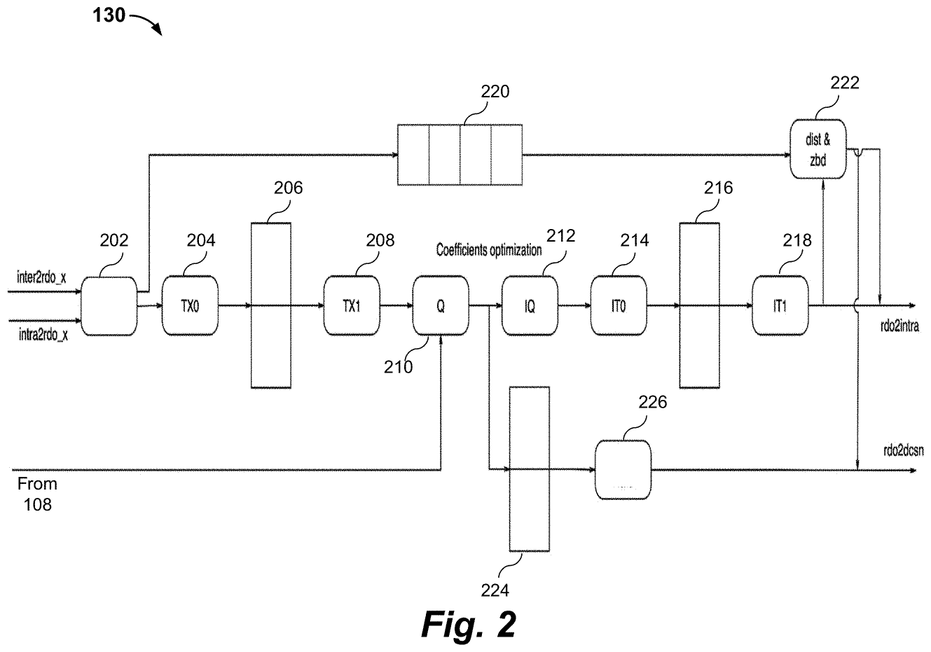

FIG. 2 illustrates an exemplary block diagram of RDO module 130. RDO module 130 includes an arbiter and buffer module 202 for receiving inputs from inter prediction module 122 and intra prediction module 128, respectively. The received inputs include the residue data (i.e., the differences between the source/original pixels and the predicted pixels) corresponding to different prediction modes. The residue data is referred to as the original residue, given by original residue=source pixels−predicted pixels. These residues are then transformed using a 2-dimensional transform performed by two stages of transform modules, TX0 module 204 and TX1 module 208, with a transpose operation module 206 in between. After the transform, the transformed values form a transform block, which is a square transform coefficient matrix with a DC coefficient and a plurality of AC coefficients. The transform coefficients are then compressed further by quantizing the coefficients via a quantization module 210.

Distortion may be based on the original residue=source pixels−predicted pixels and the reconstruction residue. For example, one metric is the sum of the squared estimate of errors (SSE), the sum of the squares of the original residue. In order to estimate the amounts of distortion experienced by the decoder, a number of processing steps are performed on the quantized coefficients. Inverse quantization (i.e., dequantization) is performed by a dequantization module 212 and an inverse transform is performed by two stages of inverse transform modules, IT0 module 214 and IT1 module 218, with a transpose operation module 216 in between. The results after the inverse transform are then compared with the original block of residual pixels at the output of a buffer 220 by a distortion estimation module 222, such that the amounts of distortion corresponding to different prediction modes are determined and sent to decision module 126.

The rates associated with sending the data corresponding to a block in a bitstream are also estimated by RDO module 130. One component of the rate is the coefficient rate, which is the rate associated with sending the quantized coefficients in the bitstream. The quantized coefficients at the output of quantization module 210 are sent to a ping-pong buffer 224 and a token rate module 226, where the rate associated with a particular block may be estimated. The rates are estimated by token rate module 226 without performing the actual encoding, because the actual encoding of the bitstream is computationally intensive and requires additional information, e.g., neighbor dependency or other neighbor information, which is not available. Coefficient rate estimation by token rate module 226 is performed for every transform unit (TU) that goes through the RDO process in mode decision module 104. The rate estimation is based on the quantized coefficients.

Rate control (RC) is an essential element of modern video encoders. By means of rate control, an encoder estimates the available number of bits to meet a specific bandwidth or file size goal and maintains it for the duration of the video stream, while achieving the best video quality for those conditions. Typically, rate control is not a normative part of a video coding standard; therefore, improved rate control techniques would be desirable.

Typically, the inputs to a rate control method are bit statistics and frame statistics. Bit statistics include past frame bits, the Quantization Parameter (QP), target bits, and Hypothetical Reference Decoder (HRD) buffer constraints. Frame statistics include the encoded quality, past frame complexity, and present frame complexity. The output of rate control is the QP for the next encoded video frame. The QP for a typical video encoder determines a tradeoff between the residual error (distortion) and the number of encoded bits for the frame. It should be recognized that while the QP value for the next frame is decided by rate control based on the prior statistics and encoder data, the final outcome of the decision, i.e., the residual error (distortion) and the number of coded bits of the frame are not known until the encoder finishes encoding a given video frame. Only then can the frame encoder update the information in the rate control unit, which is used for the decisions for subsequent frames.

In a video encoder, a rate control mechanism may include the following steps:

1) Estimate the frame complexity and target bits for the frame.

2) Choose a QP that gives the best trade-off between the controlling rate and overall quality.

3) Encode the frame.

4) Update the number of encoded bits and other frame statistics.

As the rate control process estimates the frame complexity, the process also decides on the group of pictures (GOP) and the key aspects of the GOP structure, including the next keyframe, user enforced GOP interval constraints, target bits for the frames in the group, the boost factor to distribute the bits across the group, etc. Depending on the use cases, first-pass analysis data for a number of frames may be completed ahead of time, and the data may be used for rate control algorithms. The improved technique may be used in any type of video encoder. The libvpx implementation of the VP9 standard is used in the present application as an illustrative example. It should be recognized that the improved technique may be used in any type of video encoders.

In the present application, a video to be encoded using a codec is received. A first-pass analysis of the frames of the video is performed, including by collecting first-pass statistics data for each of the frames of the video. A specific frame of the video is selected for boosting an encoding rate of the specific frame. At least a portion of the first-pass statistics data is provided to a model to determine a boost factor for the specific frame. The encoding rate for the specific frame is determined using the boost factor.

Libvpx is an open source VP9 encoder implementation frequently used as a reference by developers. As an illustrative example, a rate control process in libvpx and modifications to the process are provided. However, it should be recognized that the improved rate control techniques may be used in other video encoding formats as well.

Libvpx has a two-pass constrained quality encoding method. Two-pass encoding, also known as multi-pass encoding, is a video encoding strategy used to retain the best quality during conversion. In the first pass of a two-pass encoding, the input data from the source clip is analyzed to collect some statistics. In the second pass, the collected data from the first pass is used to make appropriate decisions for selecting encoding parameters for the second pass, thereby achieving the best encoding quality. In libvpx, a very fast first-pass analysis of the entire video stream is done, and the resulting statistics are used for computing target frame sizes and planning bit distribution across the stream.

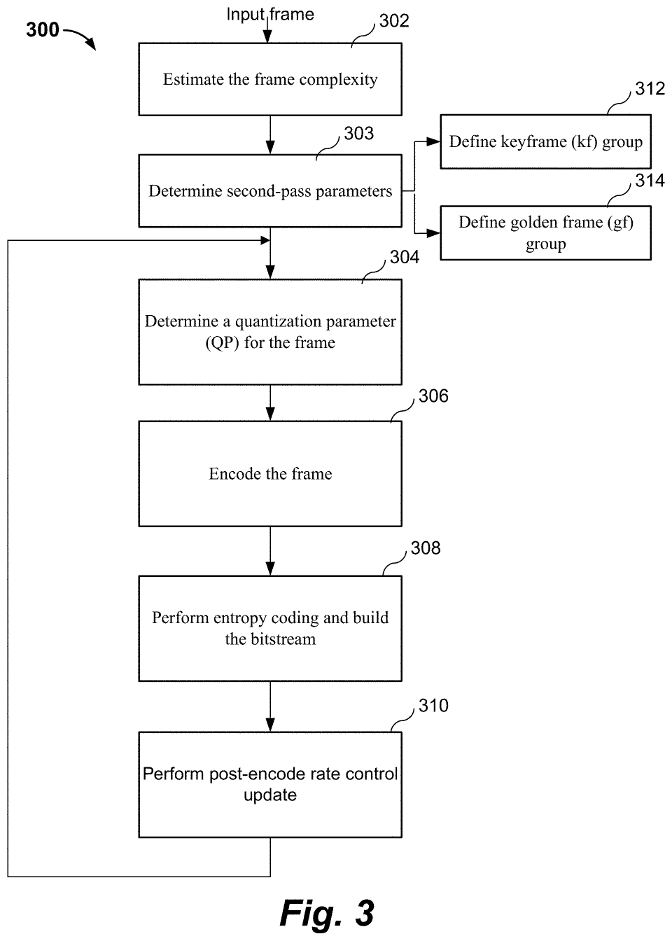

FIG. 3 illustrates a process 300 for a second main encoding pass in libvpx. The loop in FIG. 3 is repeated for every encoded frame. At step 302, the frame complexity is estimated. At step 303, the second-pass parameters are determined. At step 304, a quantization parameter (QP) for the frame is determined. The quantization parameter for the current frame is determined based on the maximum and minimum frame sizes and the current quantization parameter.

At step 306, the frame is encoded. Frame encoding includes the computations for mode decision, transform coefficients calculations, and residual calculations for each superblock in the frame. At step 308, entropy coding is performed and the bitstream is built. Entropy coding is a final step, where previously generated mode decision and transform coefficients are packed using the entropy coding method according to the standard. VP9 uses a tree-based Boolean non-adaptive binary arithmetic encoder to encode all the syntax elements.

At step 310, the post-encode rate control update is performed. This final step is a post-encode update, in which the rate control process is informed about the size of the encoded frame. This is necessary for calculating the instantaneous state of the buffer and for the rate estimation used for a closed loop rate control algorithm.

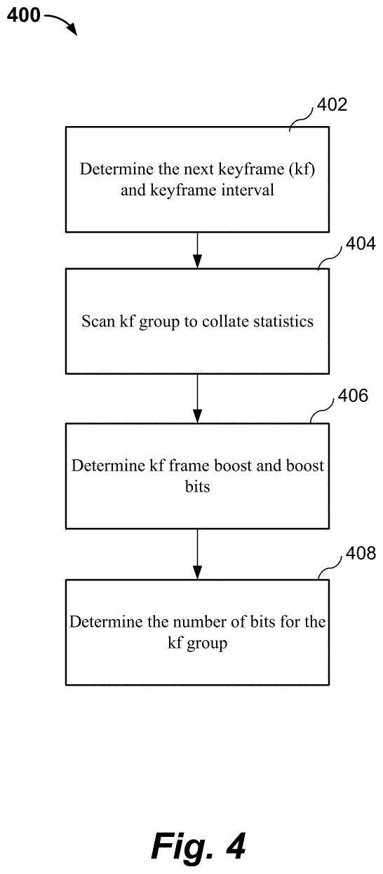

At step 303, as the rate control process determines the second-pass parameters, the process determines the keyframe (kf) group at step 312 and the golden frame (gf) group at step 314. FIG. 4 illustrates an exemplary process 400 for determining the keyframe group. At step 402, the next keyframe (kf) and the keyframe interval are determined. Once the next kf and the kf interval are decided based on scene cut and user constraints, the number of bits to assign to the kf group is calculated based on the remaining bits and the relative complexity of the section.

At step 404, the kf group is scanned to collect and accumulate various statistics, which are used for determining the number of bits to spend on the kf group, monitoring the static sections, and deciding the kf boost.

The kf boost controls the amount of boost given to the keyframe. In some embodiments, it is a percentage of the average per-frame bitrate, with the special (and default) value 0 meaning the feature is off, i.e., no frame boost and the average bitrate target is used. For example, to allow 100% more bits, i.e., 2X, in a keyframe rather than an average frame, the kf boost is set to 100.

At step 406, the kf boost and boost bits are determined. The frame boost is calculated as shown in Equation (1) below.

$$frame\_boost = ( err\_per \_mb * active\_area ) / inter\_error \qquad ( 1 )$$

where err_per_mb is the error per macroblock, and active_area is the area that has been discounted for image masks, bars, and other zero energy areas.

In addition, the baseline numbers used in QP correction and scaling are also empirically derived. Depending on the kf boost, the boost bits, i.e., the number of bits to allocate for the keyframe itself, are calculated.

At step 408, the number of bits for the kf group is determined. The number of bits that should be assigned to the kf group is recalculated by adjusting the keyframe bits.

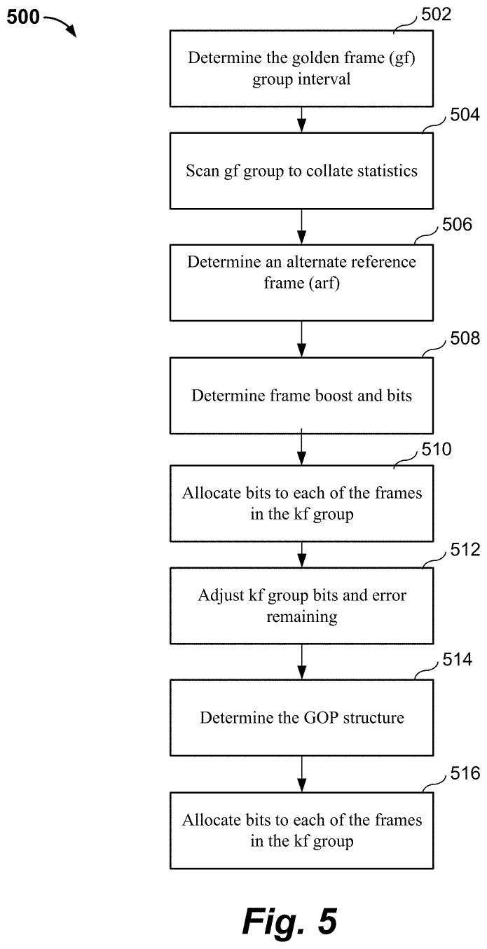

FIG. 5 illustrates an exemplary process 500 for determining the golden frame (gf) group. A kf group may contain multiple gf groups and for each gf group, process 500 is executed. At step 502, the golden frame (gf) group interval is determined. For a new gf group, the maximum and minimum intervals for the gf group are set.

At step 504, the gf group is scanned to collect and accumulate various statistics of the frames in the gf group. These statistics are used to determine static sections, make the decision to use an alternate reference frame (arf), and determine the frame boost. At step 506, an alternate reference frame (arf) is determined. At step 508, the frame boost and boost bits are determined. Similar to kf, the boost calculations are based on empirical data for error per macroblock and QP correction and scaling.

At step 510, bits are allocated to each of the frames in the kf group. Depending on the kf group bits, the gf group error and the remaining kf group error, the total number of bits are allocated to the whole gf group.

At step 512, kf group bits and the remaining errors are adjusted. Depending on the boosted frames, the extra bits to be used for the boosted frames in the group are calculated and the number of bits to be assigned to the gf group are recalculated. Based on this, the kf group bits and the remaining errors are adjusted as well.

At step 514, the GOP structure is determined. The gf group layer depth and order are determined. At step 516, bits are allocated to each of the frames in the kf group. Bits are allocated for each of the frames in the gf group.

Referring back to process 300 in FIG. 3, at step 304, a quantization parameter (QP) for the next frame is determined based on the maximum and minimum frame sizes and the current quantization parameter. Frame size prediction is used to estimate the number of bits at quantization module 210 (Q), which in turn relies on predicted bits per macroblock.

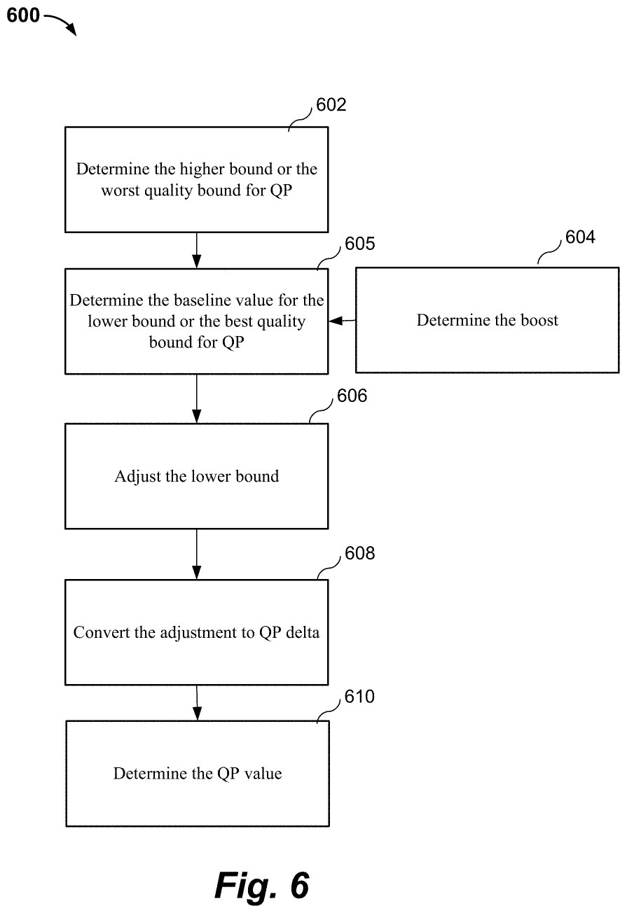

FIG. 6 illustrates an exemplary process 600 for determining the quantization parameter (QP). First, the maximum and minimum bounds for QP are determined.

At step 602, the higher bound or the worst quality bound is calculated during the golden frame group decision. Based on the recent history, the expectations of bits per macroblock are adjusted to pick a maximum value for QP that will be high enough to encode the content at the given rate.

At step 604, the frame boost is determined. At step 605, the baseline value for the lower bound or the best quality bound for QP is determined. The lower bound or the best quality bound is calculated on top of the worst quality and the calculated frame boost during the kf/gf group decisions.

At step 606, the lower bound is adjusted. For kf, the adjustment factor for the lower bound is computed based on an empirical equation based on a motion measure. For gf, the lower bound is linearly fitted depending on the layer depth.

At step 608, the adjustment is converted to QP delta. At step 610, the QP value is determined. The adjustment factor is converted to QP delta and converted to the QP value.

The frame boost determined in the rate control process is used to allocate the per frame bits in the GOP and select the QP value. The frame boost calculations in Equation (1) are based on empirical data, such as error per macroblock, and therefore the allocation of the frame bits may be inefficient since the frame boost is determined based on past data.

Equation (2) below provides an improved technique to determine the frame boost in the rate control process.

$$frame\_boost = ( bsf * err\_per \_mb * active\_area ) / inter\_error \qquad ( 2 )$$

In Equation (2), err_per_mb is the error per macroblock; active_area is the area that has been discounted for image masks, bars, and other zero energy areas. As shown in Equation (2), frame_boost is further scaled by a boost scale factor (bsf) that accounts for the changes in the frame complexity over time. As changes to the frame_boost will affect the target bits and QP, which may translate to poor video quality based on objective or subjective measures, the boost scaling factor (bsf) is a content-dependent correction factor that is updated dynamically.

First-pass statistics in a two-pass encoding can provide information about the coding complexity of each frame. In the first-pass statistics, there are five types of raw data being calculated:

sum of squaredestimate of errors (SSE) of intra prediction

SSE of inter prediction with LAST FRAME

SSE of inter prediction with GOLDEN FRAME

Block noise energy

Motion vectors

The raw data is compared with thresholds or directly accumulated for different statistics at the frame-level, which can later be employed by the rate control algorithm for deciding the second-pass parameters. In the original libvpx encoder, first-pass data is used for planning the allocation of bits for future frames within each GOP (Group of Pictures) interval. In addition to that, the first-pass data can also be used for an improved boost scaling factor prediction model. The scaling factor can be computed using a linear or nonlinear prediction model as a function of computed first-pass statistics data for the given video frame.

In some embodiments, machine learning is used to train the prediction model with data samples for each encoded frame (frame sizes and first-pass statistics data). These data samples are classified into bins, according to a frame coding type in VP9, i.e., a level in a GF structure (e.g., Inter, ARF, GF_ARF, KF). The prediction model for the boost scaling factor may be trained separately for each frame-type bin. For each frame type bin, a set of samples (e.g., 10K samples) is randomly selected as the machine learning training data set, and another set of samples (e.g., 10K samples) is randomly selected as the test data set. Since the number of keyframes for Intra frame coding type is few, fewer samples (about 1.5K) may be used.

In some embodiments, the boost scaling factor (bsf) for the Intra frame coding type may be computed by a linear prediction model from the first-pass data. In some embodiments, the prediction model is a linear regression model that uses four parameters from the first-pass statistics data that are relevant to the keyframe complexity estimate. One of the four parameters is the intra_error, which is an estimate of the per-pixel intra coding error. Another of the four parameters is the frame_noise_energy (an estimate of the per-block (16×16) noise level). Another two parameters are intra_skip_pct and intra_smooth_pct. Both intra_skip_pct and intra_smooth_pct indicate the percentage of blocks whose intra coding error is less than a threshold, where intra_skip_pct uses a much smaller threshold value. In some embodiments, a linear regression model with these input variables (i.e., 4 variables+intercept) is used.

In some embodiments, the boost scaling factor (bsf) for the Inter frame coding type may be computed by a prediction model from the first-pass data. Since there are more than 20 first-pass statistics, not all of them have equal significance for rate prediction. Therefore, only a portion of them is selected to be used in the prediction model. In some embodiments, Principal Component Analysis (PCA) is used to determine how many variables (dimensions) are sufficient for the model. PCA is also used to determine which of the variables may have the highest significance for the top principal components (which are eigenvectors of the covariance matrix). In some embodiments, the variables (8 variables+intercept) selected to be used in the model are: sr_coded_error (estimate of per-block inter coding error with GF), frame_noise_energy, pcnt_motion (percentage of blocks coded with last frame), pcnt_second_ref (percentage of blocks coded with GF), pcnt_intra_low, pcnt_intra_high (pcnt_intra_low and pcnt_intra_high are percentages of intra coded blocks with low and high variances, respectively), intra_skip_pct, and intra_smooth_pct.

Inter frames are classified by levels, where level 0 is a basic inter frame, level 2 is a reference frame (ARF), and level 3 is a GF ARF frame. For frames at level 3 (GF ARF), a linear regression model with eight input variables is used as the prediction model.

In some embodiments, the boost scaling factor (bsf) may be computed by a nonlinear prediction model from the first-pass data. In some embodiments, random forest regression may be used. Random forest is a supervised learning algorithm, with a group of decision trees, and is trained with a bagging method. In some embodiments, a multilayer artificial neural network (ANN) may be used. Both models are available in a Scikit-learn, a software machine learning library for the Python programming language, that may be used for data analysis and modeling experiments.

Overall, ANN prediction models appear to be a good model for predicting Inter frame sizes. However, from a complexity perspective, a linear regression method may be preferable. It simplifies the implementation, especially given the firmware memory limitations involved in the HW encoder.

Although the foregoing embodiments have been described in some detail for purposes of clarity of understanding, the disclosure is not limited to the details provided. There are many alternative ways of implementing the disclosure. The disclosed embodiments are illustrative and not restrictive.

What is claimed is:

1. A method, comprising:
receiving a video to be encoded using a codec;
performing a first-pass analysis of frames of the video including by collecting first-pass statistics data for the frames of the video;
selecting a specific frame of the video for boosting an encoding rate of the specific frame;
providing at least a portion of the first-pass statistics data to a model to determine a boost factor for the specific frame; and
using the boost factor in determining the encoding rate of the specific frame.

2. The method of claim 1, wherein the first-pass analysis comprises a first pass of a two-pass video encoding process.

3. The method of claim 1, wherein the specific frame of the video comprises a keyframe or a golden frame.

4. The method of claim 1, wherein the encoding rate of the specific frame is based at least in part on an average per-frame bitrate.

5. The method of claim 1, wherein the boost factor comprises a boost scaling factor for scaling an estimated frame boost value, wherein the scaled frame boost value is used to determine an amount of increase to the encoding rate of the specific frame.

6. The method of claim 5, wherein using the boost factor in determining the encoding rate of the specific frame comprises:
determining the scaled frame boost value including by using the boost factor, a measure of error per macroblock, a measure of an area of the specific frame, and an inter prediction error value.

7. The method of claim 5, wherein the boost scaling factor is associated with a measure of change in frame complexity over time.

8. The method of claim 1, wherein providing at least the portion of the first-pass statistics data to the model to determine the boost factor for the specific frame comprises configuring a prediction model to predict the boost factor for a frame coding type based on one or more types of first-pass statistics.

9. The method of claim 8, wherein the one or more types of first-pass statistics are selected based on a Principal Component Analysis (PCA).

10. The method of claim 8, wherein the prediction model comprises a machine learning model.

11. The method of claim 8, wherein the prediction model comprises a linear prediction model.

12. The method of claim 8, wherein the prediction model comprises a non-linear prediction function.

13. A system, comprising:
a processor configured to:
receive a video to be encoded using a codec;
perform a first-pass analysis of frames of the video including by collecting first-pass statistics data for the frames of the video;
select a specific frame of the video for boosting an encoding rate of the specific frame;
provide at least a portion of the first-pass statistics data to a model to determine a boost factor for the specific frame; and
use the boost factor in determining the encoding rate of the specific frame; and
a memory coupled to the processor and configured to provide the processor with instructions.

14. The system of claim 13, wherein the boost factor comprises a boost scaling factor for scaling an estimated frame boost value, wherein the scaled frame boost value is used to determine an amount of increase to the encoding rate of the specific frame

15. The system of claim 14, wherein using the boost factor in determining the encoding rate for the specific frame comprises:
determining the scaled frame boost value including by using the boost factor, a measure of error per macroblock, a measure of an area of the specific frame, and an inter prediction error value

16. The system of claim 14, wherein the boost scaling factor is associated with a measure of change in frame complexity over time.

17. The system of claim 13, wherein providing at least the portion of the first-pass statistics data to the model to determine the boost factor for the specific frame comprises configuring a prediction model to predict the boost factor for a frame coding type based on one or more types of first-pass statistics.

18. The system of claim 17, wherein the one or more types of the first-pass statistics are selected based on a Principal Component Analysis (PCA).

19. A computer program product embodied in a non-transitory computer readable medium and comprising computer instructions for:
receiving a video to be encoded using a codec;
performing a first-pass analysis of frames of the video including by collecting first-pass statistics data for the frames of the video;
selecting a specific frame of the video for boosting an encoding rate of the specific frame;
providing at least a portion of the first-pass statistics data to a model to determine a boost factor for the specific frame; and
using the boost factor in determining the encoding rate of the specific frame.

20. The computer program product of claim 19, wherein providing at least the portion of the first-pass statistics data to the model to determine the boost factor for the specific frame comprises configuring a prediction model to predict the boost factor based on one or more types of first-pass statistics, for a frame coding type.
